(19) United States
(12) Patent Application Publication
(10) Pub. No.: US 2004/0203666 A1
(43) Pub. Date: Oct. 14, 2004

(54) System and method for aggregating network resources

(76) Inventors: Neal C. Foster, Manalapan, NJ (US); Alan P. Salzman, Morristown, NJ (US); Matthew G. Samonek, Southlake, TX (US)

Correspondence Address: MOTOROLA INC, 600 NORTH US HIGHWAY 45, ROOM AS437, LIBERTYVILLE, IL, 60048-5343, US

(21) Appl. No.: 10/384,129

(22) Filed: Mar. 7, 2003

(51) Int. Cl. H04M 3/42

(52) U.S. Cl. 455/414.1; 455/418; 455/551

(57) ABSTRACT

There is provided a system and method for aggregating network resources among a plurality of mobile stations. The multiplexing network entity (104) includes a subscriber database (406) and a server (404) coupled to the subscriber database. The subscriber database (406) is capable of storing an identification, a access number, and a personal identification number (“PIN”) associated with a mobile station (106). The server (404) is capable of assigning the access number and the PIN to the mobile station (106) after detecting an initiation of provisioning proceedings (600). For the method, the initiation of the provisioning proceedings is detected (602). The access number and the PIN are then assigned to the mobile station (106). The multiplexing network entity (104) also includes a billing manager (500) that is capable comparing a first billing report (504) generated by a network operator and a second billing report (506) generated by a GE server. The mobile station (106) includes a client (306) that is capable of initiating (602) the provisioning proceedings (600), and receiving (606) provisioning information from a remote server (104).

### FIELD OF THE INVENTION

The present invention relates generally to the field of wireless communication systems and, more particularly, to the field of managing network resources utilized by mobile stations of wireless communication systems.

### BACKGROUND OF THE INVENTION

Wireless communication systems are generally provided by various service providers. Existing wireless communication systems provide each user with unrestricted access to communication within one or more defined geographic areas. For example, users are provided with any available access to a service provider's network within a user's local area, and the provided services are generally only limited by the maximum capacity of the network.

In providing the services of a wireless communication system to users, the service providers incur substantial costs in installing the communication network and continue to incur substantial costs in maintaining the communication network, such as the cost of using call management and billing software. Equipment manufacturers and service providers of the wireless communication industry are focused on reducing these installation and operational costs directly. The service providers continue to provide each user with unrestricted access to communication within one or more defined geographic areas.

Accordingly, there is need for a wireless communication system that minimizes the operational costs of a wireless communication system while maintaining a user acceptable level of communication service. It is further desirable to reduce the operational costs of a wireless communication system without incurring substantial installation costs.

### BRIEF DESCRIPTION OF THE DRAWINGS

FIG. 1 is a block diagram of a preferred embodiment of the wireless communication system.

FIG. 2 is a state diagram representing various, preferred operational states of the mobile station of FIG. 1.

FIG. 3 is a block diagram representing certain components of the mobile station of FIG. 1.

FIG. 4 is a block diagram representing certain components of the server of FIG. 1.

FIG. 5 is a block diagram representing an auditing controller of the server of FIG. 1.

FIG. 6 is a flow diagram of a preferred operation of provisioning proceedings of the wireless communication system of FIG. 1.

FIG. 7 is a flow diagram of a preferred operation of camping proceedings of the wireless communication system of FIG. 1.

FIG. 8 is a flow diagram of a preferred operation of origination proceedings of the wireless communication system of FIG. 1.

FIG. 9 is a flow diagram of a preferred operation of termination proceedings of the wireless communication system of FIG. 1.

### DETAILED DESCRIPTION OF THE PREFERRED EMBODIMENT(S)

The present invention is directed to a system and method for minimizing the operation costs of a wireless communication system by providing an efficient service offering that provides a subscriber acceptable level of communication service. Although the system and method may be an integral part of a newly-constructed network, the system and method may also be installed and implemented at minimal costs by adapting to existing infrastructure.

The wireless communication system aggregates network resources or, more particularly tokens, over a plurality of subscribers through the use of the multiplexing network entity. This aggregation of tokens spreads the network operation component of the network operator's costs across several subscribers and, effectively, reduces the per subscriber cost for subscribers of the communication services. This approach combines the economic power of multiple low ARPU (“Average Revenue Per User”) subscribers so that network operators can serve them efficiently.

In order to conserve on tokens, only a predetermined quantity of tokens, may be assigned to a particular group of mobile stations at any point in time. For the preferred embodiment, a token is a dialable number such as a Mobile Identification Number (“MIN”) and a Mobile Station ISDN (“MSISDN”) that represents the telephone number of the mobile station. However, it is to be understood that a token may also be other types of addresses for mobile stations, such as time slots of a communication trunk. The number of potential subscribers of the tokens is greater than the total number of tokens accessible by the group of potential subscribers. By sharing the limited tokens among the group of mobile stations, the network operator's costs may be minimized. Also, by efficiently assigning the tokens to the mobile stations of the group, the effects on quality of service may be minimized.

The present invention is a multiplexing network entity of a communication network, and a method thereof, for aggregating a predetermined quantity of network resources among a plurality of mobile stations. The multiplexing network entity includes a subscriber database and a server coupled to the subscriber database. The subscriber database is capable of storing an identification, a access number, and a personal identification number (“PIN”) associated with a mobile station. The server is capable of assigning the access number and the PIN to the mobile station after detecting an initiation of provisioning proceedings. For the method, the initiation of the provisioning proceedings is detected. The access number and the PIN are then assigned to the mobile station.

The multiplexing network entity also includes a billing manager that is capable comparing a first billing report generated by a network operator and a second billing report generated by a GE server. The first billing report includes a token identification and a first network usage corresponding to the token identification. The second billing report includes the same token identification as the first billing report as well as a second network usage corresponding to the token identification. The first network usage is determined by the network operator, and the second network usage is determined by the GE server. For the method, the first billing report provided by the network operator and the second billing report provided by the GE server are identified. The first and second billing reports are then compared to each other.

The present invention is also a mobile station of a communication network, and a method thereof, for aggregating a predetermined quantity of network resources. The mobile station comprises a GE client that is capable of initiating provisioning proceedings, and receiving provisioning information from a remote server. The provisioning information including a access number and a personal identification number (“PIN”) associated with the mobile station. For the method, the provisioning proceedings are initiated. Provisioning information is then received from the remote server.

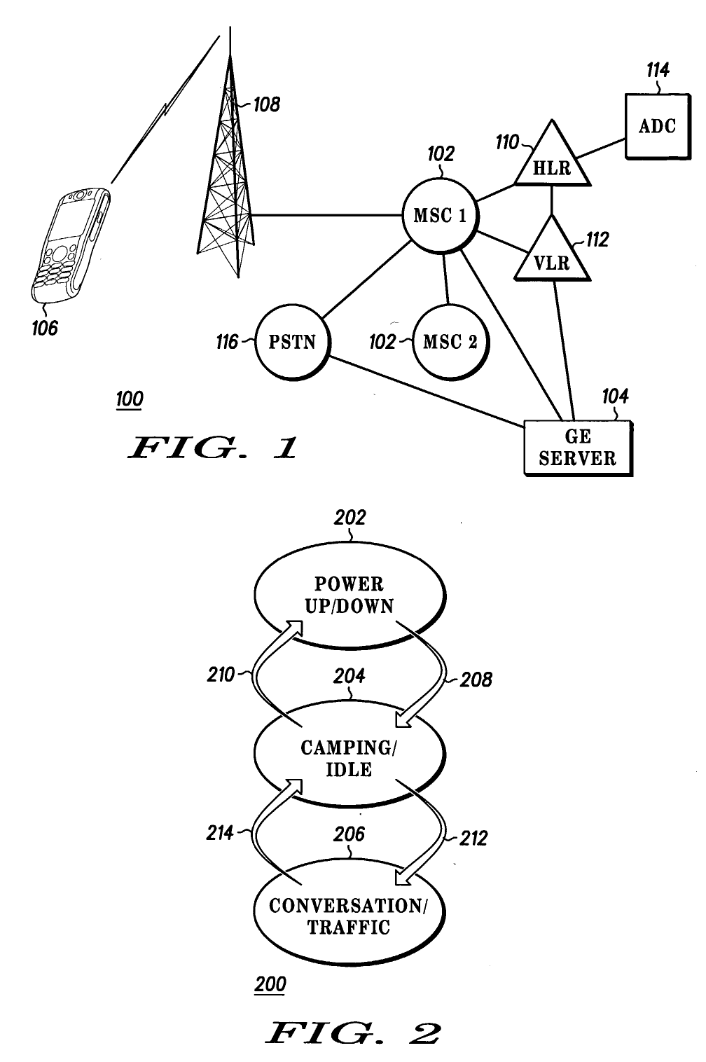

Referring to FIG. 1, a wireless communication system 100 in accordance with the present invention includes a plurality of mobile stations communicating with a network infrastructure. The network infrastructure includes at least one Mobile Switching Center (“MSC”) 102 and at least one multiplexing network entity, such as the Growth Engine (“GE”) server 104 shown in FIG. 1. For the preferred embodiment, the wireless communication system 100 includes at least one GE mobile station (“GE-MS”) 106 and at least one GE server (“GE-S”) 104 as described herein, but may communicate with each other over any type of air interface and network elements, such as the MSC 102, that are generally used for voice and data communications. The network infrastructure will be configured such that a pool of tokens is reserved for subscribers of the present service for aggregating network resources. Preferably, this pool of tokens is under the control of, or at least supervised by, the GE server 104. The ratio of subscribers to amount of resources in the pool can be configured to address specific usage patterns. The service may be configured by a network operator or any other entity having an interest in the wireless communication system 100.

Typically, the network infrastructure of the wireless communication system 100 also includes at least one Base Station 108, at least one Home Location Register (“HLR”) 110, at least one Visitor Location Register (“VLR”) 112, and at least one Authentication Center (“AuC”) 114. The MSC 102 is the hub of the communication system and, primarily, controls calls to and from other telephone and data systems, such as for example a Public Switched Telephone Network (“PSTN”) 116. The MSC 102 provides all the necessary functionality involved in registering, authenticating, location updating, and call routing for a subscriber. The HLR 110 is a database that includes subscriber information, such as the operation data about the subscriber's mobile station. The VLR 112 is a database, generally updated by the MSC 102, that includes certain subscriber information retrieved from the HLR 110. The VLR 112 retrieves this subscriber information from the HLR 110 when the subscriber is located within an area controlled by the VLR. The AuC 114 determines whether to validate each subscriber logging-on to the communication system. If the AuC 114 validates a subscriber, then the subscriber is allowed access to the network infrastructure.

As described in detail below, the GE server 104 is part of the network infrastructure and, thus, may be connected to a wireless network. The GE server 104 may serve as an HLR 110 and AuC 114 for the GE mobile station 106. Thus, for full functionality within the present service for aggregating network resources, the GE mobile station 106 would communicate and otherwise operate via the GE server 104.

Referring to FIG. 2, there is provided a state diagram representing various preferred operational states 200 of the GE mobile station 106. For the preferred embodiment, the GE mobile station 106 may have a power up/down state 202, a camping/idle state 204, and a conversation/traffic state 206. The GE mobile 106 transcends among these states 200 as tokens and registrations are assigned and released. For the power up/down state 202, the GE mobile station 106 transitions 208 to the camping/idle state when it sends a registration message to the GE server 104 upon power up, and the GE mobile station 106 transitions 210 power up/down state when it sends a de-registration message to the GE server 104 upon power down.

The GE mobile station 106 is considered to be in the camping/idle state 204 when it registers with the GE server 104 but is not communicating over a connection, i.e., the GE mobile station 106 is not “on a call”. The GE mobile station 106 transitions 212 to the conversation/traffic state 206 after it successfully receives a token from the GE server 104 and accesses a traffic channel. The GE mobile station 106 transitions 210 to the power up/down state 202 after it de-registers with the GE server 104 and powers off.

The GE mobile station 106 is considered to be in the conversation/traffic state 206 when it has a token assigned to it by the GE server 104 and is accessing a traffic channel. The GE mobile station 106 transitions 214 to the camping/idle state 204 after it drops the traffic channel and releases the assigned token.

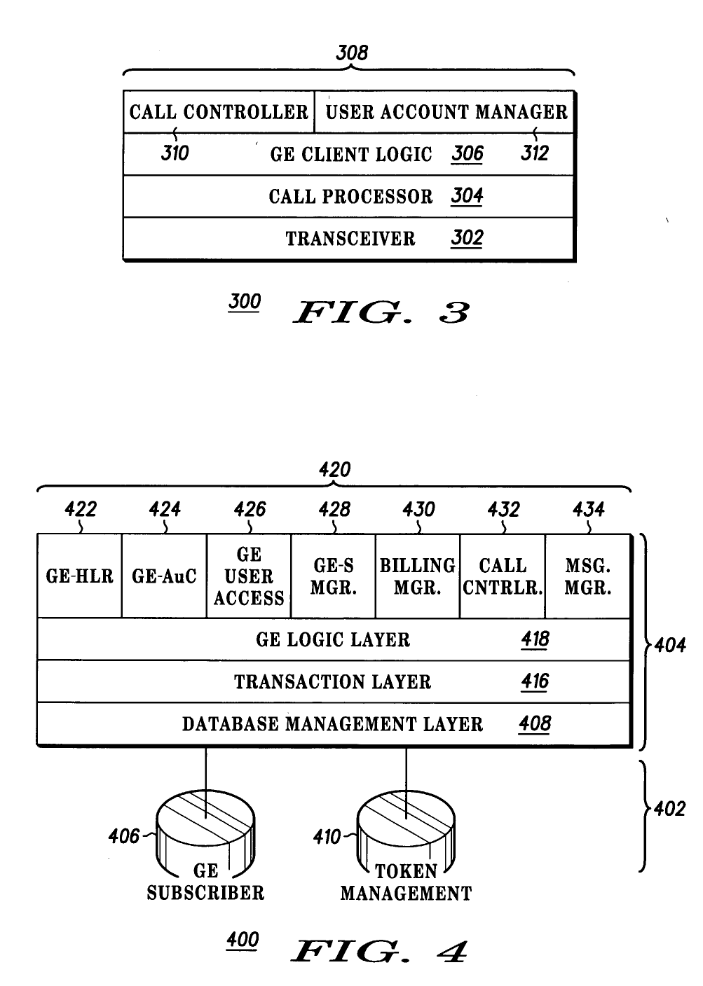

The GE mobile station 106 includes mobile station components that are commonly known in the art such as a processor, memory, a transceiver, a subscriber interface, a component interface, and a power supply that are interconnected for coordinated operation. For example, the subscriber interface may include an earpiece, a microphone, a display, a keypad, and the component interface may include a SIM (“Subscriber Identity Module”) card receptacle and a headset plug. Also, the processor executes, and the memory stores, various operations of a mobile station. FIG. 3 focuses on the particular components and operations of the GE mobile station 106 that are of interest for the present invention.

Referring to FIG. 3, there is provided a block diagram representing certain internal components 300 of the GE mobile station 106. The internal components 300 of the GE mobile station 106 include a transceiver 302, a call processor 304, a GE client logic (“GE client”) 306, and a GE mobile station services layer 308. The transceiver 302 provides the underlying radio access technology or technologies, such as GSM, TDMA, CDMA, UMTS, CDMA2000, WCDMA, and the like, for communicating with the network infrastructure. The call processor 304 includes the radio technology signaling stack for directing the transceiver to communicate with the network infrastructure using the same underlying radio access technology or technologies as the transceiver 302. For the preferred embodiment, the transceiver 302 is a modem and the call processor 304 is software that resides in memory and is executed by the processor of the GE mobile station 106.

The GE client 306 and the GE mobile station services layer 308 are important components of the GE mobile station 106 for operating within the present service for aggregating network resources. For the preferred embodiment, similar to the call processor 304, the GE client 306 and the GE mobile station services layer 308 are software residing in memory that are executed by the GE mobile station's processor. The GE client 306 provides basic logic for communication with the GE server 104. The GE mobile station services layer 308 includes various growth engine components that the GE mobile station 106 provides. These components include a call controller 310 that controls call origination functions, token request, and the like, as well as the user account manager 312 that allows for a subscriber to access account and usage information.

Similar to the GE mobile station 106, the GE server 104 includes server components that are commonly known in the art such as a processor, memory, and a network connection that are interconnected for coordinated operation. For example, the memory may include volatile and non-volatile memory, and the network connection may include circuitry for communicating with various types of wireless and wired elements of the wireless communication system 100. Like the GE mobile station 106, the processor and the memory are used to perform various operations of a server. FIG. 4 focuses on the particular components and operations of the GE server 104 that are of interest for the present invention.

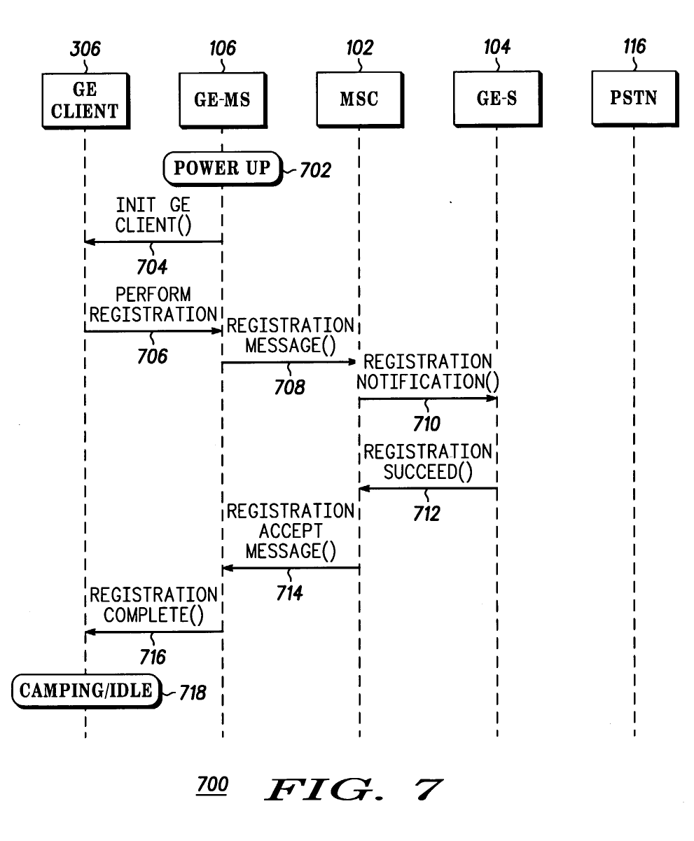

Referring to FIG. 4, there is provided a block diagram representing certain internal components 400 of the GE server 104. The GE server 104 includes a data store 402 and software-based server 404. The data store 402 includes two types of data that serve as the central location for subscriber information and token management. A GE subscriber database 406 stores information that is used to identify each GE mobile station 106 and keep track of usage information for each GE mobile station 106. The GE subscriber database 406 may be accessed by the database management layer 408 of the GE server 104 for various purposes, such as during the registration proceeding of the GE mobile with the GE server 104 as described below in regard to FIG. 7.

The GE subscriber database 406 is used to track dynamic identifications and status of a subscriber. In addition, if subscribers may be identified by a personal identification number (“PIN”) for termination calls, then the PIN for each subscriber may be tracked by the GE subscriber database 406. For the preferred embodiment, the GE subscriber database 406 includes an identification of the mobile station 106, an access number, and a PIN for each subscriber. The identification of the preferred embodiment is an identification number such as an Electronic Serial Number (“ESN”) that is a permanent and unique number assigned to the GE mobile station 106 at the time of manufacture, or an International Mobile Subscriber Identity (“IMSI”) that is a unique number within a SIM card that identifies the subscriber to the system. The access number of the preferred embodiment is a telephone number that a caller may use to access the GE server 104, and the PIN is provided by the caller to assist the GE server in identifying the called party. The GE subscriber database 406 may also store other types of information for each subscriber, such as account balance information, status information, and HLR information. Examples of status information include the state of each subscriber, namely power up/down state, camping/idle state, and conversation/traffic state, as described in reference to FIG. 2.

A token management database 410 stores information that is used to manage the status of a token and the usage of a particular token. The token management database 410 tracks any tokens that have not yet been allocated to a subscriber or have been released by a subscriber. For the preferred embodiment, the tokens are dialable numbers such as Mobile Identification Numbers (“MIN's”) or Mobile Station ISDN's (“MSISDN's”) that are available for use by a GE mobile station 106. When a particular GE mobile station 106 desires to transfer from a camping/idle state 204 to a conversation/traffic state 206, the GE server 104 must check the token management database 410 to determine whether any tokens are available for assignment to the particular GE mobile station 106.

Records of the GE subscriber database 406 and the token management database 410 are capable of being linked together so that, when a token is assigned to a GE mobile station 106, the identification of a particular GE mobile station by the GE subscriber database may be associated with a token of the token management database assigned to the GE mobile station. Records of the GE subscriber database 406 and the token management database 410 may be linked using various methods such as, but not limited to, including a pointer in a record of one database to reference a record in the other database, copying an assigned token to a field of the appropriate record of the GE subscriber database, copying a corresponding identification to a field of the appropriate record of the token management database, and the like.

The software-based server 404 of the GE server 104 includes components that manage the transactions with the data store and operate the functional logic of the GE server 104. These components include the database management layer 408, the transaction layer 416, the GE Logic layer 418, and the GE server services layer 420. The database management layer 408 provides access to the data store to the other layers 416, 418, 420 of the software-based server 404. The transaction management layer 416 manages the reliability of complete transactions with the data store 402. An example of such transactions includes, but is not limited to, recharging of minutes and the like. The GE Logic layer 418 provides the logic and signaling information to drive basic server functions and communication with the GE mobile station 106. Examples of such functions include, but are not limited to, obtaining a token, determining the remaining quantity of tokens, and the like.

The GE server services layer 420 provides services, typically all of the services, provided by the GE server 104. Preferably, the services include a GE-HLR 422, a GE-AuC 424, a GE user access 426, a GE server manager 428, a billing manager 430, a call controller 432, and a message manager 434. The GE-HLR 422 and the GE-AuC 424 generally perform functions similar to other Home Location Registers and Authentication Centers. The GE user access 426 permits a subscriber to perform various functions such as update minutes, provision a GE mobile station 106, access usage information, etc. The GE server manager 428 permits a network operator to add tokens, obtain server logs, obtain subscriber reports, etc. The billing manager 430 provides the billing functionality for the subscribers. The billing functionality includes, but is not limited to, decrementing functions, auditing functions, billing report generation, etc. The call controller 432 manages call routing and control functionality for incoming and outgoing calls. This functionality includes, but is not limited to, token assignment, locating a subscriber, rerouting incoming calls, call blocking, etc. The message manager 434 manages the delivery of incoming and outgoing messages, particularly messages of a short messaging system (“SMS”).

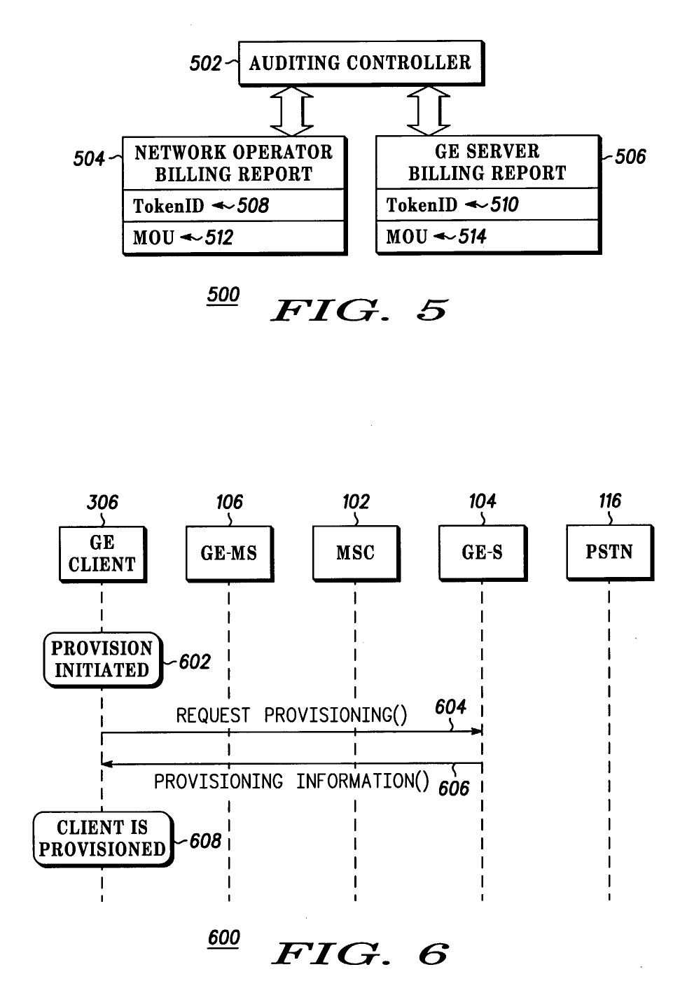

Referring to FIG. 5, the billing manager 430 (shown in FIG. 4) provides auditing functions 500 unique to the present service for aggregating network resources. In particular, an auditing controller 502 of the billing manager 430 identifies, by access, billing reports 504 generated by a network operator's equipment and compares them to billing reports 506 generated by the GE server 104. Each report includes an identification for at least one token (“TokenID”) 508, 510 and its corresponding network use, preferably minutes of use (“MOU”) 512, 514. The audit of the auditing controller 502 is performed by comparing the network usage of a token provided by the network operator's billing report 504 against the network usage of the same token provided by the GE billing manager's report 506. If the two billing reports 504, 506 do not reconcile, then the auditing controller 502 determines that the subscriber or subscribers who utilized the token may be billed erroneously. Accordingly, the results of the comparison are reported to the network operator, particularly if the two billing reports 504, 506 do not reconcile. Therefore, the billing manager 430 is able to maximize the accuracy and integrity of token-based billing by the present service.

FIGS. 6 through 9 provide flow diagrams representing preferred operations of the wireless communication system 100. In particular, these flow diagrams represents preferred sequences of communication among the GE client logic (“GE client”), call processing and transceiver 302, 304 of the GE mobile station 106 (“GE-MS”), a Mobile Switching Center (“MSC 102”), and the GE server 104 (“GE-S”), as well as a Public Switched Telephone Network (“PSTN”) 116.

Referring to FIG. 6, there is provided a flow diagram of a preferred provisioning proceeding 600 of the wireless communication system 100. The GE-S 104 detects an initiation of a provisioning proceeding. For the preferred embodiment, as shown in FIG. 6, this detection occurs when the GE client 306 initiates 602 the provisioning proceeding 600 and sends a request provisioning signal 604 to the GE-S 104. The request provisioning signal 604 includes an identification of the mobile station 106 and an authentication key associated with the identification. For the preferred embodiment, the identification is one of an Electronic Serial Number (“ESN”) and an International Mobile Subscriber Identity (“IMSI”). After the GE-S 104 receives the request provisioning signal 604, the GE-S assigns an access number and a personal identification number (“PIN”) to the mobile station 106 and associates them with the identification of the mobile station. The GE-S 104, then, returns a provisioning information signal 606 to the GE client 306 that includes the identification, the access number and the PIN. The provisioning information signal 606 may also include other information available from the GE subscriber database 406, such as account balance information, status information, and HLR information. Thus, in response to receiving the provisioning information signal 606, the GE-MS 106 becomes provisioned 608.

Referring to FIG. 7, there is provided a flow diagram of a preferred operation of camping proceedings 700 of the wireless communication system 100. The GE-MS 106 may move-on to the camping proceedings 700 after the GE-MS 106 detects that it has been powered-up 702. Typically, a GE-MS 106 powers up when a subscriber activates a button of the GE-MS 106's subscriber interface. Upon detecting that the GE-MS 106 has been powered-up, the GE-MS 106 sends a GE client initialization signal 704 to the GE client 306.

In response to receiving the GE client initialization signal 704, the GE client 306 attempts to register with the GE-S 104. In particular, the GE client 306 sends a perform registration signal 706 to the GE-MS 106. The GE-MS 106, then, sends a registration message 708 to the MSC 102. In response to receiving the registration message 708, the MSC 102 sends a registration notification 710 to the GE-S 104. Once the GE-S 104 receives the registration notification 710, the GE-S determines whether the MS client 306 may be properly registered. For the preferred embodiment, the GE-S 104 extracts an identification from the received registration notification 710 corresponding to the identification. For example, the identification may be an Electronic Serial Number (“ESN”) that is a permanent and unique number assigned to the GE-MS 106 at the time of manufacture, and an International Mobile Subscriber Identity (“IMSI”) that is a unique number within a SIM card that identifies the subscriber to the wireless communication system 100. The GE client 306 may also include an address of the GE-S 104 with the perform registration signal 706 and, thus, the registration message 708 and registration notification 710, to assist the VLR directing communication to the GE-S. Next, the GE-S 104 determines whether the identification is valid by, for example, comparing it with known information in its GE subscriber database 406.

The result of the GE-S registration check is sent via a registration succeed signal 712 from the GE-S 104 to the MSC 102, a registration accept message 714 sent from the MSC 102 to the GE-MS 106, and a registration complete signal 716 forwarded to the GE client 306 by the GE-MS. If the result of the GE-S registration check is positive, then the GE client 306 will transfer 718 from a power up/down state 202 to a camping/idle state 204. Also, a registration acknowledgment is sent to the GE client 306 and the status is updated in the GE subscriber database 406 of the GE server 104. For the preferred embodiment, the identification is an ESN corresponding to the GE-MS 106 or an IMSI corresponding to a SIM card coupled to the GE-MS. On the other hand, if the result of the GE-S registration check is negative, then the GE client 306 should attempt to register with the GE-S 104 again (or lack communication capabilities), because the GE client 306 must achieve a camping/idle state 204 before it may move on to the conversation/traffic state 206.

The GE-MS 106 may move-on to origination proceedings or termination proceedings after it has achieved successful registration during the camping proceedings 700. The GE server 104 controls the dynamic allocation of tokens upon subscriber request. A subscriber request may be triggered when a call is placed to or from the GE-MS 106. The GE-MS 106 requests a call setup for the origination proceedings, and the GE server 104 requests a call setup for the termination proceedings.

During the transition from camping/idle state 204 to conversation/traffic state 206, the GE client is allocated tokens from an available pool of tokens. If tokens are available during this transition period, then the calling party will be connected with the called party and the call will be completed. If tokens are unavailable during this transition period, then the calling party will be notified that call can not be completed, and the call setup process will be aborted.

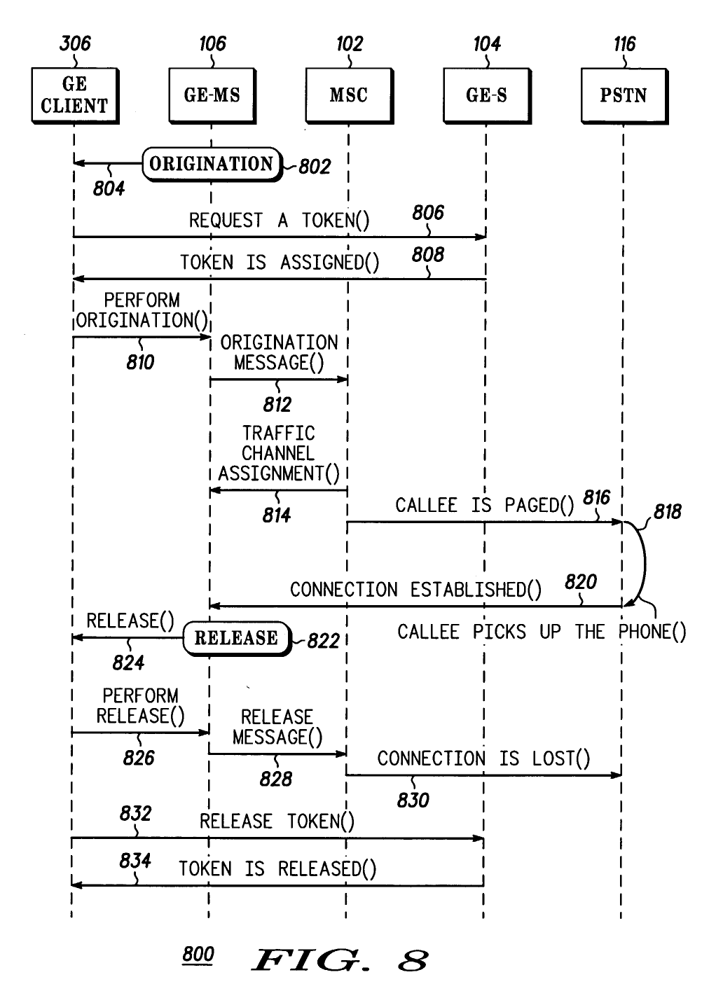

Referring to FIG. 8, there is provided a flow diagram of a preferred operation of origination proceedings 800 of the wireless communication system 100. The GE-MS 106 detects 802 when a call is originated by the GE-MS 106. Typically, a subscriber accesses a user interface of the GE-MS 106 to dial a number, such as one associated with a MIN or MSISDN, and presses a “SEND” key to initiate an origination attempt. After detecting 802 a call origination, the GE-MS 106 sends an origination signal 804 to the GE client 306. The GE client 306, then, sends a request for a token 806 to the GE-S 104. If a token is available, then the GE-S 104 will return a positive response via a token assignment signal 808 to the GE client 306. For the preferred embodiment, the GE-S 104 checks the token management database 410 to determine whether any tokens are available. If a token is assigned to the GE client 306, then the GE subscriber database 406 and/or the token management database 410 are updated to associate the assigned token with the corresponding GE-MS 106, and the call is placed. For the preferred embodiment, the GE subscriber database 406 is updated and linked to the token management database 410 so that the subscriber's identification is a dialable number such as a Mobile Identification Number (“MIN”) or a Mobile Station ISDN (“MSISDN”). On the other hand, if a token is not available, then the GE-S 104 will return a negative response via the token assignment signal 808 to the GE client 306 and, thus, the GE client will remain in the camping/idle state 204 and the call will not be placed.

To place the call, the GE client 306 sends a perform origination signal 810 to the GE-MS 106, and the GE-MS sends an origination message 812 to the MSC 102. The MSC 102, in response, provides a traffic channel assignment 814 to the GE-MS 106. Thereafter, the MSC 102 sends a page 816 to the called party (“callee”), the called party answers 818 the call, and a connection is established 820 between the GE-MS 106 and the called party. The MSC 102 may reach the called party via the PSTN 116 or, if the called party participates in the network operator's network, then the MSC 102 may reach the called party at his or her mobile station without accessing the PSTN. If a traffic channel is not available or the called party does not answer the call, then the call will not be completed.

Subsequently, the GE-MS 106 or the MSC 102 detects 822 when a call is disconnected by the GE-MS or the called party, respectively. The GE-MS 106 may detect that a subscriber of the GE-MS 106 pressed an “END” key to terminate the call, or the MSC 102 may detect that the called party is no longer connected to the call.

In a situation where the GE-MS 106 detects 822 termination of the call, the GE-MS 106 sends a call release message 824 to the GE client. In response, the GE client 306 sends a perform release signal 826 to the GE-MS 106, and the GE-MS sends a similar release message 828 to the MSC 102. The MSC 102 then terminates 830 the connection between the GE-MS 106 and the called party. During or after the discontinuation of the call, the token is no longer assigned to the GE client 306 and returned to the available pool. In particular, the GE client 306 sends a token release signal 832 to the GE-S 104, and the GE-S returns an acknowledging token release response 834 to the GE client. Also, the token management database 410 and/or GE subscriber database 406 of the GE-S 104 are updated accordingly.

FIG. 8 represents a scenario in which the GE-MS 106 detects termination of the call via subscriber input at the GE-MS, but it is to be understood that the present service for aggregating network resources is equally applicable to scenarios in which the GE-MS 106 detects termination of the call from other sources. For example, the GE-MS 106 may receive a termination signal from another component of the network infrastructure, such as the MSC 102. In such case, the origination proceedings 800 would still operate similarly to the procedure described above and shown in FIG. 8. Also, similar to the situation above, the token is no longer assigned to the GE client and returned to the available pool during or after the discontinuation of the call.

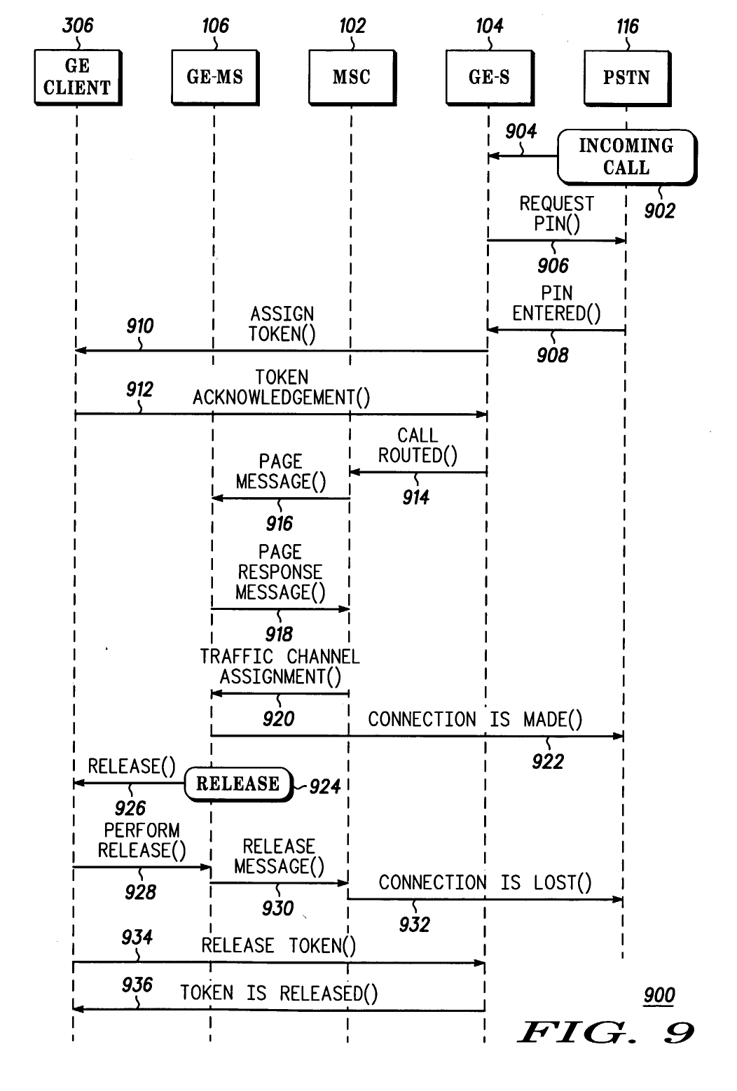

Referring to FIG. 9, there is provided a flow diagram of a preferred operation of termination proceedings 900 of the wireless communication system 100. The GE-S 104 detects when a call is directed 902 from a calling party to the GE-MS 106. The calling party may contact the GE-S 104 via the MSC 102 if the calling party is utilizing the network infrastructure of the wireless communication system 100. If the calling party is not utilizing the network infrastructure, then the calling party may contact the GE-S via the PSTN 116.

In addition, the calling party may contact the GE-MS 106 via a two stage dialing process or a specially-assigned dialing number. For the preferred embodiment, calls to subscribers of the present service are completed via a two stage dialing process. The calling party dials a common access number, receives a prompt to enter a personal identification number (“PIN”), and then enters the appropriate PIN to reach the intended subscriber. As shown in FIG. 9, the GE-S 104 receives an incoming call 904 (from, for example, the PSTN), sends a PIN request signal to the calling party 906, and waits for a response to request 908. When the GE-S 104 receives the requested PIN of the intended subscriber, the GE-S may lookup the PIN in the GE subscriber database 406 to find the corresponding identification of the subscriber. This solution allows the GE-S 104 to map subscribers without a special, dedicated mobile station identification. In the alternative, each subscriber may have a specially-assigned dialing number that the GE-S may lookup in the GE subscriber database 406 to find the corresponding identification of the intended subscriber.

The GE-S 104, then, determines whether a token is available for assignment to the GE client 306. For the preferred embodiment, the GE-S 104 checks the token management database 410 to determine whether any tokens are available. If a token is available, then the GE-S 104 will proceed with the assignment and send a token assignment signal 910 to the GE client 306. The GE-S 104 also updates the GE subscriber database 406 and/or token management database 410 to associate the assigned token with the corresponding GE-MS 106. For the preferred embodiment, the GE subscriber database 406 is updated and linked to the token management database 410 so that the subscriber's identification is associated with a dialable number such as a Mobile Identification Number (“MIN”) or a Mobile Station ISDN (“MSISDN”). The GE client 306, in response, returns a token acknowledgment signal 912 to the GE-S 104. On the other hand, if a token is not available, then the GE-S 104 will notify the calling party that the call cannot be completed, and the GE client 306 will remain in the camping/idle state 204.

After a token is assigned to the GE-MS 106, the GE-S 104 sends a call routed signal 914 to the MSC 102, and the MSC 102 sends a page message 916 to the GE-MS. The GE-MS 106, in response, returns a page response message 918 to the MSC 102 acknowledging receipt of the page message 916. The MSC 102 provides a traffic channel assignment 920 to the GE-MS 106. Next, the GE-MS 106 makes 922 a connection to the calling party via the MSC 102 to connect the call. The calling party may reach the MSC 102 via the PSTN 116 or, if the calling party participates in the network operator's network, then the calling party may reach the MSC 102 at the calling party's mobile station without accessing the PSTN. If a traffic channel is not available, then the call will not be completed.

The remaining operations of the termination proceedings 900 are similar to the operations of the origination proceedings 800, described above. In particular, the GE-MS 106, directly or indirectly, detects when a call is disconnected by the GE-MS or the called party, respectively. In response to detecting 924 termination of the call, the GE-MS 106 sends a call release message 926 to the GE client 306, the GE client sends a perform release signal 928 to the GE-MS, and the GE-MS sends a similar release message 930 to the MSC 102. The MSC 102 then terminates 932 the connection between the GE-MS 106 and the called party. Thereafter, the GE client 306 sends a token release signal 934 to the GE-S 104, and the GE-S returns an acknowledging token release response 936 to the GE client 306. Also, the GE subscriber database 406 and/or token management database 410 of the GE-S 104 are updated accordingly.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of a multiplexing network entity of a communications network for aggregating network resources among a plurality of mobile stations, the method comprising the step of:
detecting an initiation of provisioning proceedings; and
assigning a access number and a personal identification number (“PIN”) to the mobile station.

2. The method of claim 1, wherein assigning a access number and PIN to the mobile station includes associating the access number and the PIN with an identification of the mobile station.

3. The method of claim 1, further comprising sending provisioning information including the identification, the access number and the PIN to the mobile station.

4. The method of claim 2, wherein associating the access number and the PIN with an identification of the mobile station includes associating the access number and the PIN with one of an Electronic Serial Number (“ESN”) and an International Mobile Subscriber Identity (“IMSI”).

5. The method of claim 1, wherein detecting the initiation of provisioning proceedings includes receiving a provisioning request including the identification from the mobile station.

6. The method of claim 5, wherein receiving the provisioning request includes receiving an authentication key associated with the identification.

7. A multiplexing network entity of a communication network for aggregating a predetermined quantity of network resources among a plurality of mobile stations comprising:
a subscriber database being capable of storing an identification, a access number, and a personal identification number (“PIN”) associated with a mobile station; and
a server, coupled to the subscriber database, being capable of assigning the access number and the PIN to the mobile station after detecting an initiation of provisioning proceedings.

8. The multiplexing network entity of claim 7, wherein the server associates the access number and the PIN with the identification of the mobile station.

9. The multiplexing network entity of claim 7, wherein the server sends provisioning information including the identification, the access number and the PIN to the mobile station.

10. The multiplexing network entity of claim 7, wherein the identification is one of an Electronic Serial Number (“ESN”) and an International Mobile Subscriber Identity (“IMSI”).

11. The multiplexing network entity of claim 7, wherein the server receives a provisioning request including the identification from the mobile station.

12. The multiplexing network entity of claim 11, wherein the provisioning request includes an authentication key associated with the identification.

13. A method of a mobile station of a communications network for aggregating network resources, the method comprising the step of:
initiating provisioning proceedings; and
receiving provisioning information from a remote server, the provisioning information including a access number and a personal identification number (“PIN”) associated with the mobile station.

14. The method of claim 13, wherein receiving provisioning information from a remote server includes associating the access number and the PIN with an identification of the mobile station.

15. The method of claim 13, further comprising receiving provisioning information from a remote server including an identification of the mobile station, the access number, and the PIN.

16. The method of claim 13, wherein associating the access number and the PIN with an identification of the mobile station includes associating the access number and the PIN with one of an Electronic Serial Number (“ESN”) and an International Mobile Subscriber Identity (“IMSI”).

17. The method of claim 13, wherein initiating provisioning proceedings includes sending a provisioning request including the identification to the remote server.

18. The method of claim 17, wherein sending the provisioning request includes sending an authentication key associated with the identification.

19. A mobile station of a communication network for aggregating a predetermined quantity of network resources comprising:
a GE client being capable of initiating provisioning proceedings, and receiving provisioning information from a remote server, the provisioning information including a access number and a personal identification number (“PIN”) associated with the mobile station.

20. The mobile station of claim 19, wherein the GE client associates the access number and the PIN with an identification of the mobile station.

21. The mobile station of claim 20, wherein the identification is one of an Electronic Serial Number (“ESN”) and an International Mobile Subscriber Identity (“IMSI”).

22. The mobile station of claim 19, the provisioning information includes an identification of the mobile station, the access number, and the PIN.

23. The mobile station of claim 19, wherein the GE client sends a provisioning request including an identification of the mobile station to the remote server.

24. The mobile station of claim 23, wherein the provisioning request includes sending an authentication key associated with the identification.

25. A method of a multiplexing network entity of a communications network for aggregating network resources among a plurality of mobile stations, the method comprising the step of:
identifying a first billing report provided by a network operator, the first billing report including a token identification and a first network usage corresponding to the token identification, the first network usage being determined by the network operator;
identifying a second billing report provided by a GE server, the second billing report including the token identification and a second network usage corresponding to the token identification, the second network usage being determined by the GE server; and
comparing the first and second billing reports.

26. The method of claim 25, wherein comparing the first and second billing reports includes determining whether a discrepancy exists between the first network usage of the first billing report and the second network usage of the second billing report.

27. The method of claim 25, wherein the token identification is one of a Mobile Identification Number (“MIN”) and a Mobile Station ISDN (“MSISDN”) to the mobile station.

28. The method of claim 25, wherein the first and second network usages are measured by minutes of use (“MOU”).

29. A multiplexing network entity of a communication network for aggregating network resources among a plurality of mobile stations comprising:
a billing manager being configured to compare a first billing report provided by a network operator and a second billing report provided by a GE server, the first billing report including a token identification and a first network usage corresponding to the token identification, the second billing report including the token identification and a second network usage corresponding to the token identification,
wherein the first and second network usages being determined by the network operator and the GE server, respectively.

30. The multiplexing network entity of claim 29, wherein the billing manager determines whether a discrepancy exists between the first network usage of the first billing report and the second network usage of the second billing report.

31. The multiplexing network entity of claim 29, wherein the token identification is one of a Mobile Identification Number (“MIN”) and a Mobile Station ISDN (“MSISDN”) to the mobile station.

32. The multiplexing network entity of claim 29, wherein the first and second network usages are measured by minutes of use (“MOU”).
